(19) United States
(12) Patent Application Publication
(10) Pub. No.: US 2019/0327795 A1
(43) Pub. Date: Oct. 24, 2019

(54) OVEN APPLIANCE WITH DIRECT TEMPERATURE MEASUREMENT AND RELATED METHODS

(71) Applicant: Haier US Appliance Solutions, Inc., Wilmington, DE (US)

(72) Inventors: Sabrina Marie Hannah, Louisville, KY (US); Christopher Nils Naber, Louisville, KY (US)

(21) Appl. No.: 15/960,607

(22) Filed: Apr. 24, 2018

(51) Int. Cl. H05B 6/68; F24C 7/08; F24C 15/32; H05B 6/64; A23L 5/10

(52) U.S. Cl. CPC H05B 6/687; F24C 7/088; F24C 15/325; A23V 2002/00; H05B 6/6473; A23L 5/15; H05B 6/6452

(57) ABSTRACT

An oven appliance with one or more features for directly measuring a temperature of a food item in a cooking chamber of the oven appliance. The oven appliance is also configured to modify operation of at least one of a first heating element, a second heating element, and a convection fan in response to the directly measured temperature of the food item.

### FIELD OF THE INVENTION

The subject matter of the present disclosure relates generally to an oven appliance and a method for operating an oven appliance.

### BACKGROUND OF THE INVENTION

Oven appliances generally include a cabinet that defines a cooking chamber for cooking food items therein, such as by baking or broiling the food items. To heat the cooking chamber for cooking, oven appliances include one or more heating elements positioned at a top portion, bottom portion, or both of the cooking chamber. Some oven appliances also include a convection heating element and fan for convection cooking cycles. The heating element or elements may be used for various cycles of the oven appliance, such as a preheat cycle, a cooking cycle, or a self-cleaning cycle.

During a typical cooking cycle, the air and surfaces of the cooking chamber are heated to a set temperature, creating a heating environment within the cooking chamber for cooking food items that is maintained during the cooking cycle, e.g., over one or more stages. The stages of the cooking cycle typically are performed for a set amount of time, e.g., a user-selected or predetermined amount of time. However, measuring the environmental or ambient temperature within the cooking chamber is only an indirect assessment of the food item or items being prepared within the cooking chamber. As such, cooking cycles based on oven air temperature and/or set amounts of time do not account for variations in food properties such as size, shape, initial temperature, etc., or other important variations such as altitude.

Accordingly, an oven appliance with features for controlling a cooking cycle within a cooking chamber of the oven appliance based on a more direct assessment of the food item(s) would be desirable.

### BRIEF DESCRIPTION OF THE INVENTION

Aspects and advantages of the invention will be set forth in part in the following description, may be apparent from the description, or may be learned through practice of the invention.

In one exemplary embodiment, an oven appliance is provided. The oven appliance includes a cooking chamber for receipt of food items for cooking. A first heating element and a second heating element are in thermal communication with the cooking chamber. The oven appliance also includes a convection fan. The oven appliance further includes a controller in operative communication with the first heating element, the second heating element, and the convection fan. The controller is configured to directly measure a temperature of a food item in the cooking chamber and is configured to modify operation of at least one of the first heating element, the second heating element, and the convection fan in response to the directly measured temperature of the food item.

In another exemplary embodiment, a method of operating an oven appliance is provided. The method includes directly measuring a temperature of a food item in a cooking chamber of the oven appliance and modifying an operating parameter of at least one of a first heating element, a second heating element, and a convection fan in response to the directly measured temperature of the food item.

In still another exemplary embodiment, a method of operating an oven appliance is provided. The method includes directly measuring a temperature of a food item in a cooking chamber. The method also includes activating a first heating element of the oven appliance at a first power level and deactivating a second heating element of the oven appliance until the directly measured temperature of the food item reaches a first threshold. The method further includes activating the first heating element of the oven appliance at a second level and activating the second heating element of the oven appliance after the directly measured temperature of the food item reaches the first threshold and until the directly measured temperature of the food item reaches a second threshold. The method also includes intermittently activating the first heating element of the oven appliance and deactivating the second heating element of the oven appliance after the directly measured temperature of the food item reaches the second threshold, until the directly measured temperature of the food item reaches a third threshold.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary oven appliance according to one or more embodiments of the present subject matter.

FIG. 2 is a cross-sectional view of the oven appliance of FIG. 1 taken along the 2-2 line of FIG. 1.

FIG. 3 provides a schematic view of a cooking utensil as may be used with oven appliances according to the present subject matter.

FIG. 4 provides a flowchart illustrating an exemplary method for operating an oven appliance according to the present subject matter.

FIG. 5 provides a flowchart illustrating another exemplary method for operating an oven appliance according to the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. In the context of an angle or direction, such terms include values within ten degrees greater or less than the stated direction. For example, “generally vertical” includes directions within ten degrees of vertical in any direction, e.g., clockwise or counter-clockwise.

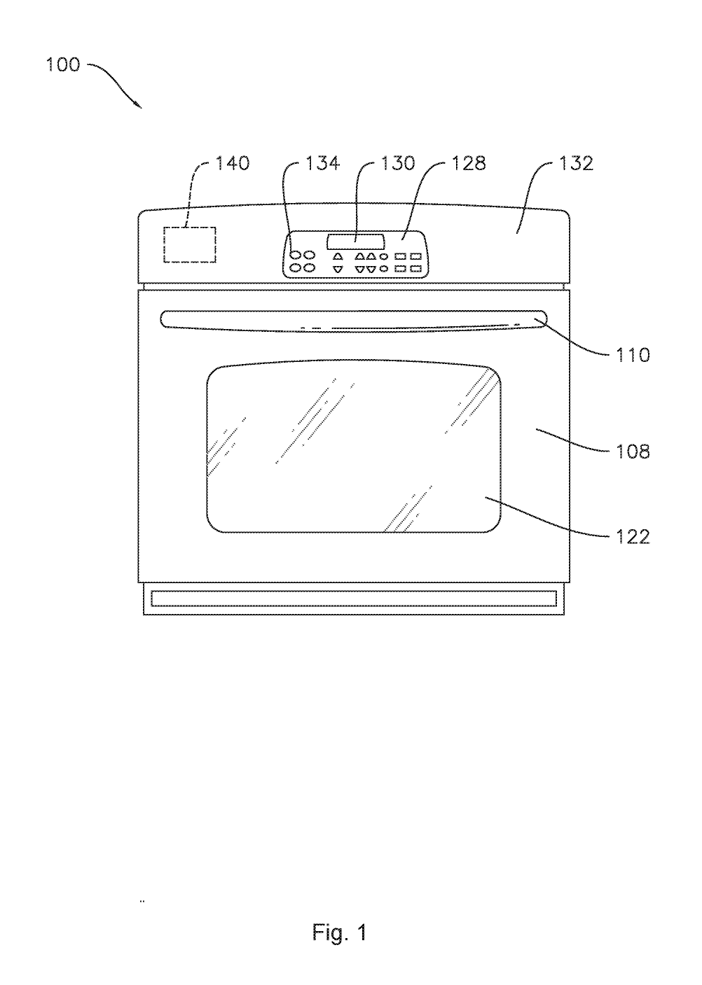

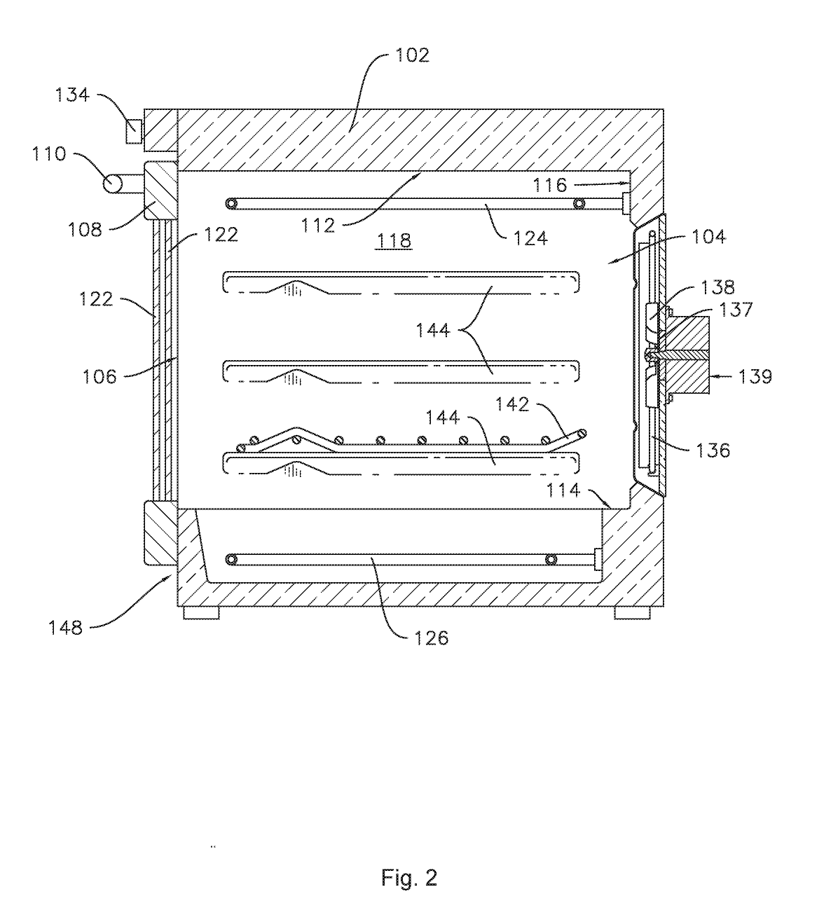

Referring to FIGS. 1 and 2, for this exemplary embodiment, oven appliance 100 includes an insulated cabinet 102 with an interior cooking chamber 104 defined by a top wall 112, a bottom wall 114, a back wall 116, and a pair of opposing side walls 118. Cooking chamber 104 is configured for the receipt of one or more food items to be cooked. Oven appliance 100 includes a door 108 pivotally mounted, e.g., with one or more hinges (not shown), to cabinet 102 at the opening 106 of cabinet 102 to permit selective access to cooking chamber 104 through opening 106. A handle 110 is mounted to door 108 and assists a user with opening and closing door 108. For example, a user can pull on handle 110 to open or close door 108 and access cooking chamber 104.

Oven appliance 100 can include a seal (not shown) between door 108 and cabinet 102 that assists with maintaining heat and cooking vapors within cooking chamber 104 when door 108 is closed as shown in FIGS. 1 and 2. Multiple parallel glass panes 122 provide for viewing the contents of cooking chamber 104 when door 108 is closed and assist with insulating cooking chamber 104. A baking rack 142 is positioned in cooking chamber 104 for the receipt of food items or utensils containing food items. Baking rack 142 is slidably received onto embossed ribs or sliding rails 144 such that rack 142 may be conveniently moved into and out of cooking chamber 104 when door 108 is open.

One or more heating elements may be provided at the top, bottom, or both of cooking chamber 104 provides heat to cooking chamber 104 for cooking. Such heating element(s) can be gas, electric, microwave, or a combination thereof. For example, in the embodiment shown in FIG. 2, oven appliance 100 includes a top heating element 124 and a bottom heating element 126, where bottom heating element 126 is positioned adjacent to and below bottom wall 114. Other configurations with or without wall 114 may be used as well.

Oven appliance 100 also has a convection heating element 136 and convection fan 138 positioned adjacent back wall 116 of cooking chamber 104. Convection fan 138 is powered by a convection fan motor 139. Further, convection fan 138 can be a variable speed fan—meaning the speed of fan 138 may be controlled or set anywhere between and including, e.g., zero and one hundred percent (0%-100%). In certain embodiments, oven appliance 100 may also include a bidirectional triode thyristor (not shown), i.e., a triode for alternating current (TRIAC), to regulate the operation of convection fan 138 such that the speed of fan 138 may be adjusted during operation of oven appliance 100. The speed of convection fan 138 can be determined by controller 140. In addition, a sensor 137 such as, e.g., a rotary encoder, a Hall effect sensor, or the like, may be included at the base of fan 138, for example, between fan 138 and motor 139 as shown in the exemplary embodiment of FIG. 2, to sense the speed of fan 138. The speed of fan 138 may be measured in, e.g., revolutions per minute (“RPM”). In some embodiments, the convection fan 138 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity.

In various embodiments, more than one convection heater, e.g., more than one convection heating elements 136 and/or convection fans 138, may be provided. In such embodiments, the number of convection fans and convection heaters may be the same or may differ, e.g., more than one convection heating element 136 may be associated with a single convection fan 138. Similarly, more than one top heating element 124 and/or more than one bottom heating element 126 may be provided in various combinations, e.g., one top heating element 124 with two or more bottom heating elements 126, two or more top heating elements 124 with no bottom heating element 126, etc.

Oven appliance 100 includes a user interface 128 having a display 130 positioned on an interface panel 132 and having a variety of controls 134. Interface 128 allows the user to select various options for the operation of oven 100 including, e.g., various cooking and cleaning cycles. Operation of oven appliance 100 can be regulated by a controller 140 that is operatively coupled, i.e., in communication with, user interface 128, heating elements 124, 126, and other components of oven 100 as will be further described.

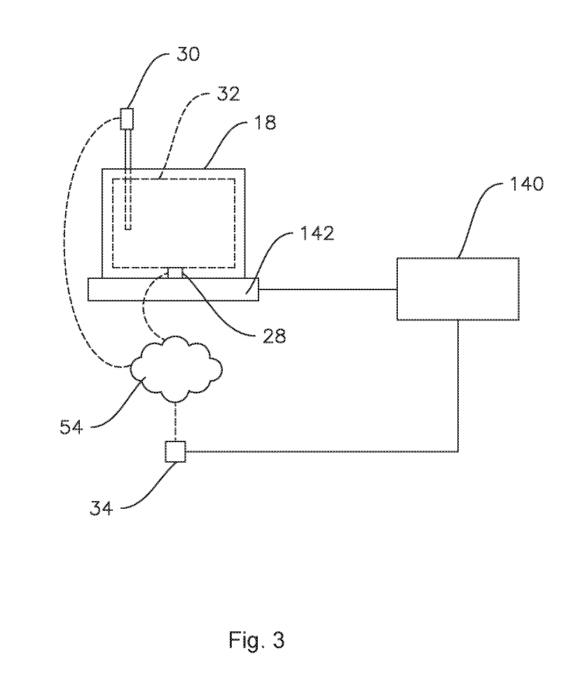

For example, in response to user manipulation of the user interface 128, controller 140 can operate the heating element(s). Controller 140 can receive measurements from one or more temperature sensors such as sensors 28 and 30 (FIG. 3) described below. Controller 140 may also provide information such as a status indicator, e.g., a temperature indication, to the user with display 130. Controller 140 can also be provided with other features as will be further described herein.

Controller 140 may include a memory and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor. The memory can store information accessible by the processor(s), including instructions that can be executed by processor(s). For example, the instructions can be software or any set of instructions that when executed by the processor(s), cause the processor(s) to perform operations. For the embodiment depicted, the instructions may include a software package configured to operate the system to, e.g., execute the exemplary methods described below. Controller 140 may also be or include the capabilities of either a proportional (P), proportional-integral (PI), or proportional-integral-derivative (PID) control for feedback-based control implemented with, e.g., temperature feedback from one or more sensors 28 and 30 (FIG. 3).

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, alarms, and/or other components as may be provided. In one embodiment, user interface 128 may represent a general purpose I/O (“GPIO”) device or functional block.

Although shown with touch type controls 134, it should be understood that controls 134 and the configuration of oven appliance 100 shown in FIG. 1 is provided by way of example only. More specifically, user interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. User interface 128 may be in communication with controller 140 via one or more signal lines or shared communication busses.

While oven 100 is shown as a wall oven, the present invention could also be used with other cooking appliances such as, e.g., a stand-alone oven, an oven with a stove-top, or other configurations of such ovens. Numerous variations in the oven configuration are possible within the scope of the present subject matter. For example, variations in the type and/or layout of the controls 134, as mentioned above, are possible. As another example, the oven appliance 100 may include multiple doors 108 instead of or in addition to the single door 108 illustrated. Such examples include a dual cavity oven, a French door oven, and others. The examples described herein are provided by way of illustration only and without limitation.

As shown in FIG. 3, a cooking utensil 18, depicted schematically, may be positioned on oven rack 142. One or more temperature sensors may be provided in the cooking chamber 104 and/or associated with the cooking utensil 18. Such sensors may measure a surface temperature of food items and/or a core temperature of food items which are cooking in the cooking chamber 104. As used therein, the “core temperature” of the food item includes any internal temperature, such as but not limited to a temperature measured at or near a center of the food item. For the example embodiment depicted, a cookware temperature sensor 28 configured for sensing the surface temperature of food item 32 (e.g., a temperature of a surface of the food item 32 which contacts the interior surface of the cooking utensil 18 where sensor 28 is embedded) and a food temperature sensor 30 configured for sensing the core temperature of the food item 32 are provided. In some example embodiments, the cookware temperature sensor 28 may be attached to or integrated into the cooking utensil 18. For example, the cookware temperature sensor 28 may be embedded within the bottom wall of the cooking utensil 18 as illustrated in FIG. 3. Alternatively, however, the cookware temperature sensor 28 may be attached to or integrated within a sidewall of the cooking utensil 18. The cookware temperature sensor 28 may be configured to sense a temperature of, e.g., a surface of the cooking utensil 18 and/or a surface of the food item 32 in contact therewith. Thus, in various embodiments, as described in more detail below, operation of the oven appliance 100 may be controlled or modified in response to the sensed temperature of the cooking utensil only, the surface of the food item only, or both temperatures.

Additionally, the food temperature sensor 30 may be positioned at any suitable location to sense a temperature of one or more food items 32 (see FIG. 3) positioned within the cooking utensil 18. For example, the food temperature sensor 30 may be a probe type temperature sensor configured to be inserted into one or more food items 32. Alternatively, however, the food temperature sensor 30 may be configured to determine a temperature of one or more food items positioned within the cooking utensil 18 in any other suitable manner.

In certain exemplary embodiments, one or both of the cookware temperature sensor 28 and the food temperature sensor 30 may utilize any suitable technology for sensing/determining a temperature of the cooking utensil 18 and/or food items 32 positioned in the cooking utensil 18. For example, one or both of the cookware temperature sensor 28 and the food temperature sensor 30 may utilize one or more thermocouples, thermistors, optical temperature sensors, infrared temperature sensors, etc.

The oven appliance 100 may further include one or more receivers 34 configured to receive a signal from the food temperature sensor 30 and from the cookware temperature sensor 28. In at least some exemplary embodiments, one or both of the cookware temperature sensor 28 and the food temperature sensor 30 may include wireless transmitting capabilities, or alternatively may be hard-wired to the receiver 34 through a wired communications bus. For the embodiment depicted, the receiver 34 is configured as a wireless receiver 34 configured to receive one or more wireless signals. Specifically, for the exemplary system depicted, both of the cookware temperature sensor 28 and the food temperature sensor 30 are configured as wireless sensors in wireless communication with the wireless receiver 34 via a wireless communications network 54. In certain exemplary embodiments, the wireless communications network 54 may be a wireless sensor network (such as a BLUETOOTH® communication network), a wireless local area network (WLAN), a point-to point communication networks (such as radio frequency identification networks, near field communications networks, etc.), or a combination of two or more of the above communications networks. The receiver 34 may be operably connected to the controller 140 via a wired communication bus (as shown), or alternatively through a wireless communication network similar to the exemplary wireless communication network 54 discussed above.

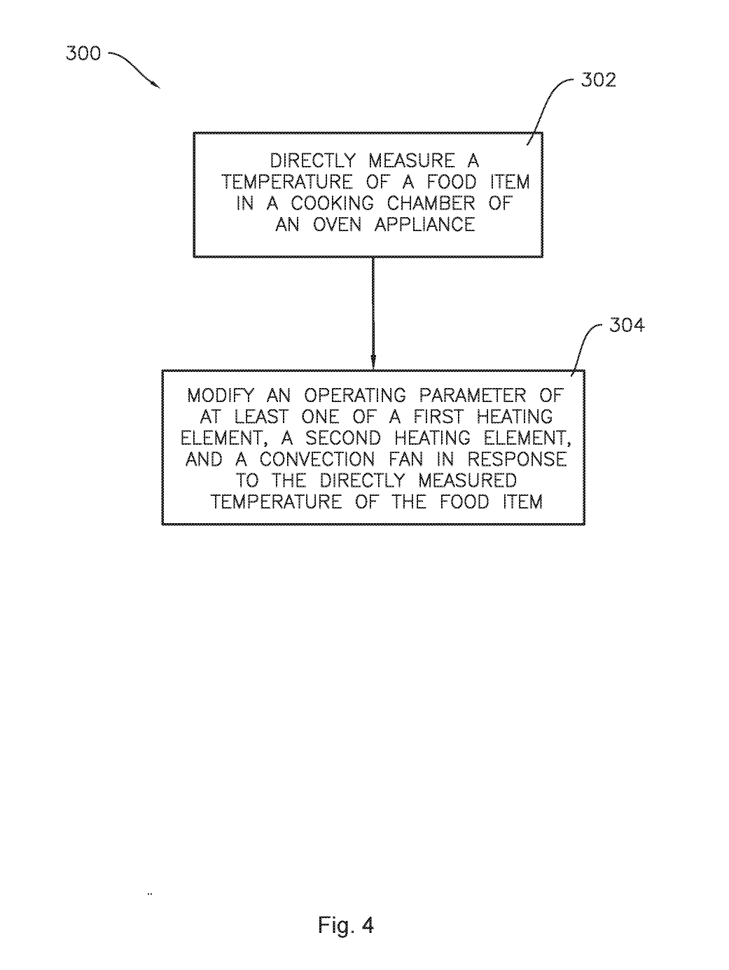

FIG. 4 illustrates an exemplary method 300 of operating oven appliance 100. Method 300 may be performed in whole or in part by controller 140 or any other suitable device or devices. At step 302, method 300 includes directly measuring a temperature of a food item, e.g., food item 32, as illustrated in FIG. 3, in the cooking chamber 104. In various embodiments, the directly measured temperature may be any temperature of the food item 32 itself and/or a cooking utensil 18 in direct contact with the food item 32 as opposed to an indirect measurement of the food temperature, e.g., an ambient temperature of the air within the cooking chamber 104. For example, the controller 140 may be in operative communication with, and may receive a signal from, a temperature sensor, wherein the signal is representative of a directly measured temperature of the food item. In some embodiments, the temperature sensor may be a cookware temperature sensor configured for sensing the surface temperature of the food item and/or a surface of the cooking utensil 18 in direct contact with the food item, e.g., cookware temperature sensor 28 as described above. Additional embodiments of the surface temperature sensor may include an infrared temperature sensor, a laser temperature sensor, or any other suitable sensor configured for sensing the surface temperature of the food item. In some embodiments, a food temperature sensor configured for sensing the core temperature of the food item may be provided as well as or instead of the surface temperature sensor. For example, in various embodiments the controller 140 may be in operative communication with a temperature probe such as probe 30 as described above to sense a core temperature of the food item 32.

At step 304, the method 300 includes modifying an operating parameter of at least one of a first heating element, a second heating element, and a convection fan in response to the directly measured temperature of the food item. The operating parameter may be modified in response to an instantaneous temperature measurement or a change in temperature over time. For example, in various embodiments, the operating parameter may be modified in response to one or more of a rate of change in the directly measured temperature over time, a change in the rate of change in the directly measured temperature over time, the directly measured temperature meeting or exceeding a predetermined threshold, and/or the directly measured temperature meeting or exceeding the predetermined threshold for at least a predetermined amount of time.

In some embodiments, the method may include modifying an operating parameter of any two of the first heating element, the second heating element, and the convection fan in response to the directly measured temperature of the food item, or all three of the first heating element, the second heating element, and the convection fan. Operating parameters which may be modified include a power level of either or both of the first heating element and the second heating element. For example, in some embodiments, modifying the power level may include modifying electrical power supplied to a resistance heating element, such as increasing, decreasing, or turning off the electrical power. As another example, in some embodiments modifying the power level may also or instead include modifying a flow rate of fuel suppled to a gas burner heating element.

Additional operating parameters which may be modified include a speed and/or direction of rotation of the convection fan. For example, the first heating element may be a traditional or radiant heating element, such as heating element 126 described above. The second heating element may, in some exemplary embodiments, be a convection heating element such as convection element 136 described above, and the convection fan may be fan 138 as described above. In various embodiments, modifying an operating parameter of the convection fan may include activating or deactivating the fan, increasing or decreasing the speed of rotation, and/or switching between the first and second directions of rotation. For example, modifying an operating parameter of the convection fan may include modifying the speed of rotation between zero percent (0%) speed, twenty-five percent (25%) speed, fifty percent (50%) speed, and one hundred percent (100%) speed, as well as any other suitable speed between 0% and 100%.

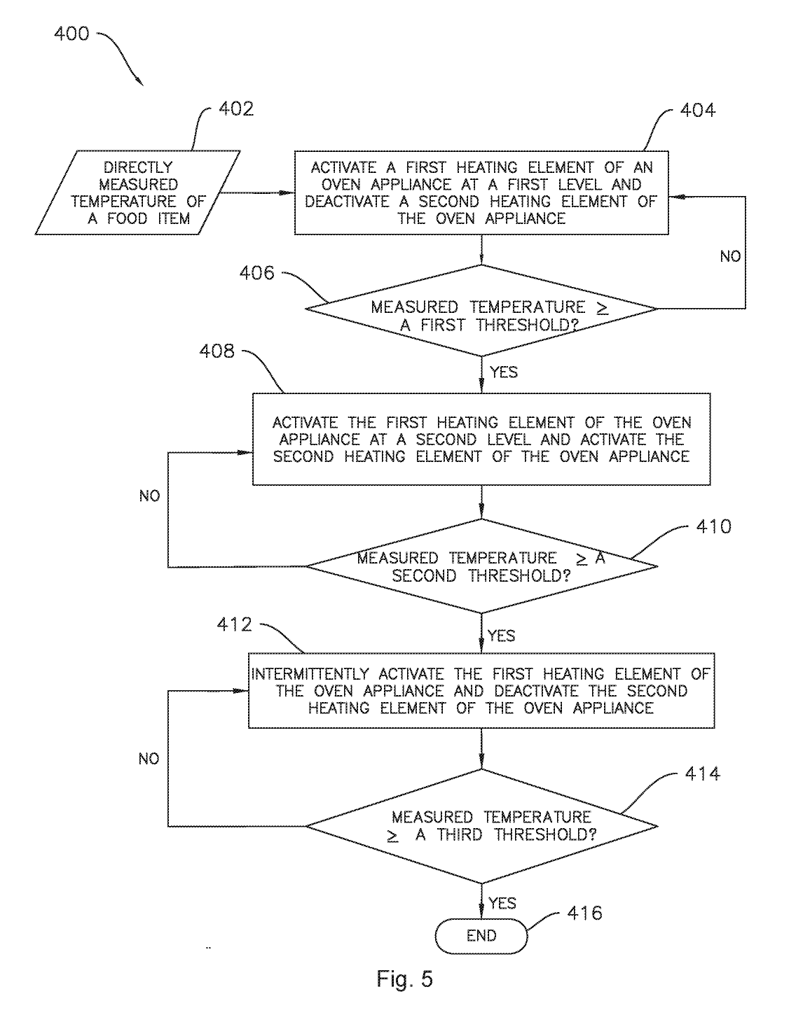

FIG. 5 illustrates another exemplary method 400 of operating oven appliance 100. Method 400 may be performed in whole or in part by controller 140 or any other suitable device or devices. Method 400 may be used in, e.g., an oven appliance 100 having a variable speed convection fan 138, where a TRIAC or other suitable device may adjust the speed of fan 138 throughout an oven cycle rather than cycling fan 138 on and off. The method 400 may be a cooking cycle comprising multiple cooking stages, e.g., three stages or more, e.g., four stages or more, e.g., five stages or more. The stages of the cooking cycle or method 400 may be delineated by temperature thresholds, in particular directly measured temperature thresholds, rather than predetermined time limits or ambient temperatures.

At step 402, the method 400 includes obtaining a directly measured temperature of a food item in a cooking chamber of an oven appliance. Similar to the exemplary embodiments discussed above, the controller 140 may be in operative communication with, and may receive a signal from, a temperature sensor, wherein the signal is representative of a directly measured temperature of the food item. The directly measured temperature may include a surface temperature and/or a core temperature, also as discussed above. In various exemplary embodiments described herein throughout, the directly measured temperature may be measured continuously or repeatedly over a time interval, e.g., every second, every three seconds, or multiple times per second, etc. Accordingly, the directly measured temperature of the food item may be measured throughout the entire cooking cycle and various stages, e.g., as described in more detail below, may be implemented or performed in response to the directly measured temperature.

In some embodiments the method 400 may include a first stage at step 404. The first stage or step 404 may include activating a first heating element of the oven appliance at a first level and deactivating a second heating element of the oven appliance until the directly measured temperature of the food item reaches a first threshold. Note that activating the first and/or second heating elements includes providing power to and operating the respective element or elements, e.g., as used herein “activating a heating element at a power level” generally includes a power level greater than zero. For example, the first power level may be about one hundred percent (100%) power. One of ordinary skill in the art will understand that “about one hundred percent” may include values less than one hundred percent. In some embodiments, the first stage may also include modifying an operating parameter, e.g., a speed of rotation and/or direction of rotation of the convection fan 138 at step 404. For example, the first stage may include deactivating the convection fan 138 such that the speed of rotation is zero.

As described above, the directly measured temperature may be a surface temperature, a core temperature, or both. Accordingly, the first threshold may be a threshold surface temperature or a threshold core temperature. As mentioned above, the directly measured temperature of the food item may be measured throughout the entire cooking cycle, thus the method 400 may include a step 406 of comparing the directly measured temperature, which may be, e.g., continuously or repeatedly measured, to the first threshold. When the measured temperature is below the first threshold at step 406, the method 400 continues to operate according to the first stage.

After the directly measured temperature of the food item reaches or exceeds the first threshold, the method 400 continues to a second stage or step 408. At step 408, the method 400 may include a second stage, e.g., activating the first heating element of the oven appliance at a second power level and activating the second heating element of the oven appliance. For example, the second power level may be less than the first power level. For example, the second power level may be between about fifty percent (50%) and about ninety percent (90%), such as about sixty percent (60%) power or more, such as about seventy percent (70%) power or more, such as about eighty percent (80%) power. In some embodiments, the second stage may also include modifying an operating parameter of the convection fan 138, e.g., the second stage may include deactivating the convection fan 138. In additional embodiments, the second stage may include any suitable modification of the operation of the convection fan, e.g., speed and/or direction, as described above.

The second stage may be continued until the directly measured temperature of the food item reaches a second threshold. For example, the method 400 may include a step 410 of comparing the directly measured temperature of the food item to the second threshold. When the measured temperature is below the second threshold at step 410, the method 400 continues to operate according to the second stage 408.

After the directly measured temperature of the food item reaches the second threshold, the method 400 may continue to a third stage or step 412. Similar to the previous stages or steps, the third stage may include modifying at least one of a power level of the first heating element, a power level of the second heating element, and a speed of the convection fan in response to the directly measured temperature of the food item, e.g., in response to the measured temperature reaching or exceeding the second threshold. In some embodiments, the third stage may include intermittently activating the first heating element of the oven appliance and deactivating the second heating element of the oven appliance until the directly measured temperature of the food item reaches a third threshold. In various embodiments, intermittently activating the first heating element may generally include operating the first heating element according to a duty cycle. The duty cycle may encompass a time period including both an on duration and an off duration. One of ordinary skill will recognize that the heating element is active and operating during the on duration, e.g., the power level of the heating element over the on duration may fall within a range wherein the lower limit of the range is greater than zero, and that the heating element is not operating during the off duration. For example, the intermittent activation of the first heating element may include a three-minute duty cycle wherein the heating element is activated for two minutes, e.g., the on duration is two minutes, and the heating element is off or deactivated for one minute. Following the completion of such duty cycle, the method may include a subsequent duty cycle with the same on and off durations for the remainder of the current stage of the cooking cycle. Intermittently activating the first heating element may include activating the first heating element at any suitable power level, e.g., about one hundred percent (100%) power or any suitable lesser value that is greater than zero during the on duration of the duty cycle. In some embodiments, the third stage may also include modifying an operating parameter of the convection fan 138, e.g., the third stage may include activating the convection fan 138. For example, the third stage may include activating the convection fan at about fifty percent (50%) speed or more, such as about seventy five percent (75%) speed or more, such as about ninety percent (90%) speed or more, such as about one hundred percent (100%) speed. In additional embodiments, the second stage may include any suitable modification of the operation of the convection fan, e.g., speed and/or direction, as described above.

The third stage may be continued until the directly measured temperature of the food item reaches a third threshold. For example, the method 400 may include a step 414 of comparing the directly measured temperature of the food item to the third threshold. When the measured temperature is below the third threshold at step 414, the method 400 continues to operate according to the third stage 412. In the illustrated embodiment of FIG. 5, the exemplary method 400 includes only three stages, such that the method 400 ends at step 416 when the directly measured temperature of the food item reaches or exceeds the third threshold.

In other embodiments, one or more methods according to the present subject matter may include more or fewer stages. For example, the method may include a fourth stage, a fifth stage, etc. Such further stages may include modifications to the operating parameters of one or more of the first heating element, the second heating element, and the convection fan. For example, such modifications may include activating the first heating element at a third power level, such as about fifty percent power or more, such as about seventy-five percent power or more, such as about ninety percent power.

As mentioned above, features illustrated or described as part of one embodiment can be used with another embodiment to yield a still further embodiment. Thus, for example, operating parameters described as part of one stage above may be provided in any other stage of another exemplary method of operating an oven appliance. For instance, a second or later power level of the first heating element may be greater than the first power level. As another example, the convection fan may be activated in one or both of the first and second stages of an exemplary cooking cycle according to the present subject matter.

The exemplary methods described herein may provide an adaptive response to changes within the food item or items as the item(s) are cooking, where changes in surface temperature and/or core temperature such as reaching a threshold temperature may be indicative of temperature-based transitions in the food. Such methods, e.g., cooking cycles, based on directly measured food temperature can provide a more specialized cooking outcome. Such methods may also provide an improved result relative to standard cycles due to consideration of temperature-based transitions in the food, such as protein structure changes, starch gelatinization, browning reactions, etc. When such transitions are reached, e.g., as indicated by a directly measured temperature of the food reaching a threshold temperature, the exemplary methods described herein may provide a responsive cooking operation by modifying one or more operating parameters of the oven appliance. In at least some embodiments, where the direct measurement of the food item temperature provides one or more of the above-described advantages as well as other advantages as will be apparent to those of skill in the art, methods according to the present subject matter may not include measuring an ambient temperature within the cooking chamber.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. An oven appliance, comprising:
a cabinet, the cabinet defining a cooking chamber configured for receipt of food items for cooking;
a first heating element in thermal communication with the cooking chamber;
a second heating element in thermal communication with the cooking chamber;
a convection fan;
a controller in operative communication with the first heating element, the second heating element, and the convection fan, the controller configured to:
directly measure a temperature of a food item in the cooking chamber; and
modify operation of at least one of the first heating element, the second heating element, and the convection fan in response to the directly measured temperature of the food item.

2. The oven appliance of claim 1, further comprising a surface temperature sensor in operative communication with the controller, wherein the directly measured temperature of the food item comprises a surface temperature.

3. The oven appliance of claim 2, further comprising a temperature probe configured for sensing a core temperature of the food item in the cooking chamber, the temperature probe in operative communication with the controller, wherein the directly measured temperature of the food item comprises the surface temperature and the core temperature.

4. The oven appliance of claim 1, wherein the controller is configured to modify one of a power level of the first heating element, a power level of the second heating element, and a speed of the convection fan in response to the directly measured temperature of the food item.

5. The oven appliance of claim 1, wherein the controller is configured to modify a power level of the first heating element, a power level of the second heating element, and a speed of the convection fan in response to the directly measured temperature of the food item.

6. The oven appliance of claim 1, wherein the controller is configured to perform a cooking cycle, the cooking cycle comprising:
directly measuring a temperature of a food item in the cooking chamber;
a first stage wherein the first heating element is activated and the second heating element is deactivated until the directly measured temperature of the food item reaches a first threshold;
a second stage after the directly measured temperature of the food item reaches the first threshold, wherein the first heating element and the second heating element are activated until the directly measured temperature of the food item reaches a second threshold; and
a third stage after the directly measured temperature of the food item reaches the second threshold, wherein the first heating element is intermittently activated and the second heating element is deactivated until the directly measured temperature of the food item reaches a third threshold.

7. The oven appliance of claim 6, wherein the directly measured temperature of the food item comprises a surface temperature and a core temperature.

8. The oven appliance of claim 7, wherein the first threshold comprises a surface temperature, the second threshold comprises a core temperature, and the third threshold comprises a surface temperature.

9. The oven appliance of claim 6, wherein the first stage comprises deactivating the convection fan, the second stage comprises deactivating the convection fan, and the third stage comprises activating the convection fan.

10. The oven appliance of claim 6, wherein the cooking cycle does not comprise measuring an ambient temperature within the cooking chamber.

11. A method of operating an oven appliance, the method comprising:
directly measuring a temperature of a food item in a cooking chamber of the oven appliance; and
modifying an operating parameter of at least one of a first heating element, a second heating element, and a convection fan in response to the directly measured temperature of the food item.

12. The method of claim 11, wherein the directly measured temperature comprises a surface temperature of the food item.

13. The method of claim 12, wherein the directly measured temperature comprises a core temperature of the food item and the surface temperature of the food item.

14. The method of claim 11, wherein modifying the operating parameter comprises modifying at least one of a power level of the first heating element, a power level of the second heating element, and a speed of the convection fan in response to the directly measured temperature of the food item.

15. The method of claim 11, wherein modifying the operating parameter comprises modifying a power level of the first heating element, a power level of the second heating element, and a speed of the convection fan in response to the directly measured temperature of the food item.

16. A method of operating an oven appliance, the method comprising:
directly measuring a temperature of a food item in a cooking chamber;
activating a first heating element of the oven appliance at a first power level and deactivating a second heating element of the oven appliance until the directly measured temperature of the food item reaches a first threshold;
activating the first heating element of the oven appliance at a second level and activating the second heating element of the oven appliance after the directly measured temperature of the food item reaches the first threshold, until the directly measured temperature of the food item reaches a second threshold; and
intermittently activating the first heating element of the oven appliance and deactivating the second heating element of the oven appliance after the directly measured temperature of the food item reaches the second threshold, until the directly measured temperature of the food item reaches a third threshold.

17. The method of claim 16, wherein the directly measured temperature of the food item comprises a surface temperature and a core temperature.

18. The method of claim 17, wherein the first threshold comprises a surface temperature, the second threshold comprises a core temperature, and the third threshold comprises a surface temperature.

19. The method of claim 16, wherein the first stage comprises deactivating a convection fan of the oven appliance, the second stage comprises deactivating the convection fan, and the third stage comprises activating the convection fan.

20. The method of claim 16, wherein the method does not comprise measuring an ambient temperature within the cooking chamber.
